(19) United States
(12) Patent Application Publication
(10) Pub. No.: US 2023/0251022 A1
(43) Pub. Date: Aug. 10, 2023

(54) REFRIGERATOR DOOR WITH REPLACEABLE DOOR PANEL

(71) Applicants: CHONGQING HAIER REFRIGERATION ELECTRIC APPLIANCE CO., LTD., Chongqing City (CN); QINGDAO HAIER REFRIGERATOR CO., LTD., Qingdao City, Shandong Province (CN); HAIER SMART HOME CO., LTD., Qingdao City, Shandong Province (CN)

(72) Inventors: XIAOFENG LI, Qingdao City, Shandong Province (CN); WENCHUN WANG, Qingdao City, Shandong Province (CN); HAO ZHANG, Qingdao City, Shandong Province (CN); JIAMING LI, Qingdao City, Shandong Province (CN)

(21) Appl. No.: 18/012,978

(22) PCT Filed: Jun. 18, 2021
(86) PCT No.: PCT/CN2021/100877

§ 371 Date: Dec. 26, 2022

(30) Foreign Application Priority Data
Jun. 30, 2020 (CN) 202010621756.3

(51) Int. Cl. F25D 23/02; A47B 96/20

(52) U.S. Cl. CPC F25D 23/028; A47B 96/20; A47B 2096/208

(57) ABSTRACT

The present invention provides a refrigerator door with a replaceable door panel, comprising: a foam door body, and a front panel detachably connected to the foam door body; wherein a hook is disposed on a rear side of the front panel, a hook groove is disposed on a front side of the foam door body, a stopper is disposed in the hook groove, the hook is caught in the hook groove, and the stopper elastically pushes and resists against the hook in a front-rear direction.

### TECHNICAL FIELD

The present invention relates to the technical field of household appliances, and particularly to a refrigerator door with a replaceable door panel.

### BACKGROUND

Along with constant development of science and technology, a refrigerator has already become one of indispensable household appliances. In current application, as the user's demands increase, the refrigerator is also required to exist as a decoration in the household environment in addition to as a household appliance; before buying the refrigerator, the user usually has many requirements for the refrigerator such as color and pattern, and a single appearance of the refrigerator affects the user's buying demands. In addition, since a service life of the refrigerator can usually be in a range of 8 years to 10 years, during use of the refrigerator by the user, the appearance of the refrigerator once bought cannot satisfy the user's demands for long-term adjustment as the environment and scenario change; in another case, the door panel also has a risk of being broken during use and transportation of the refrigerator; in the above cases, if the whole door body of the refrigerator is replaced, the replacement cost is high and the use of the refrigerator is also affected, which is not conducive in satisfying the consumer's demands.

### SUMMARY

An object of the present invention is to provide a refrigerator door with a replaceable door panel.

In order to achieve one of the above object, an embodiment of the present invention provides a refrigerator door with a replaceable door panel, wherein the refrigerator door comprise: a foam door body, and a front panel detachably connected to the foam door body; wherein a hook is disposed on a rear side of the front panel, a hook groove is disposed on a front side of the foam door body, a stopper is disposed in the hook groove, the hook is caught in the hook groove, and the stopper elastically pushes and resists against the hook in a front-rear direction.

As an optional embodiment, wherein the stopper elastically pushes and resists against the hook rearwardly in a direction perpendicular to the front panel.

As an optional embodiment, wherein the refrigerator door further comprises a frame and a front handle, the frame is attached to a rear side of the front panel, the hook is disposed at an upper end of the frame, and the front handle is disposed at a lower end of the frame, where the hook, the front handle and the frame are formed integrally.

As an optional embodiment, wherein the refrigerator door further comprises a rear handle, the rear handle is disposed in a receiving groove of the foam door body, where after the front panel is assembled with the foam door body, a snap-fitting groove on the front handle and a boss on the rear handle snap-fit each other.

As an optional embodiment, wherein a top end of the boss is provided with a through hole, a cap body is disposed on a side of the snap-fitting groove away from the boss, and a cavity of the cap body and the through hole are communicated with each other, where a bolt passes through the through hole and the cavity of the cap body in turn and interlocks the front handle with the rear handle.

As an optional embodiment, wherein the hook comprises a bent portion and a connecting portion, both ends of the connecting portion are respectively connected to the bent portion and the frame, wherein the bent portion comprises a resisting surface which is parallel and opposite to a rear side of the front panel, and wherein the resisting surface elastically abuts against the stopper.

As an optional embodiment, wherein the stopper comprises a body portion and an elastic portion, the elastic portion is located behind the body portion and protrudes towards an interior of the hook groove, and the elastic portion elastically pushes and resists against the resisting surface.

As an optional embodiment, wherein an upper end of the elastic portion is connected to a top end of the body portion, and a lower end of the elastic portion is suspended at a rear side of the body portion and forms a gap with the body portion.

As an optional embodiment, wherein the elastic portion extends obliquely downward along a top end of the body portion toward a bottom end of the body portion.

As an optional embodiment, wherein a positioning block is disposed in the hook groove, a positioning notch is disposed on the bent portion, where when the front panel is assembled on the front side of the foam door body, the bent portion is inserted in the hook groove, and the positioning notch and the positioning block snap-fit each other.

As compared with the prior art, the present invention provides a refrigerator door with a replaceable door panel, wherein the hook on the rear side of the front panel is detachably connected with the hook groove on the front side of the foam door body, the stopper in the hook groove elastically pushes and resists against the hook in the front-rear direction so that the front panel is attached to the front side of the foam door body, whereby the replacement of the front panel of the refrigerator door with the replaceable door panel is more convenient, and the appearance of the refrigerator door with the replaceable door panel is more beautiful.

### BRIEF DESCRIPTION OF THE DRAWINGS

FIG. 1 is an exploded view of a refrigerator door with a replaceable door panel according to an embodiment of the present invention as viewed from a first angle of view.

FIG. 2 is an enlarged view of a dashed region in FIG. 1.

FIG. 3 is an exploded view of the refrigerator door with a replaceable door panel in FIG. 1 as viewed from a second angle of view.

FIG. 4 is an enlarged view of a dashed region in FIG. 3.

FIG. 5A through FIG. 5C are cross-sectional views of the refrigerator door with a replaceable door panel in FIG. 1 during the assembling.

FIG. 6 is another cross-sectional view of the refrigerator door with a replaceable door panel in FIG. 1 after the assembling.

FIG. 7 is an exploded view of the refrigerator door in a further embodiment of the present invention.

### DETAILED DESCRIPTION

The present invention will be described in detail below in combination with embodiments shown in the figures. However, these embodiments do not limit the present invention, and structural or functional changes made by those having ordinary skill in the art according to these embodiments are all included in the protection scope of the present invention.

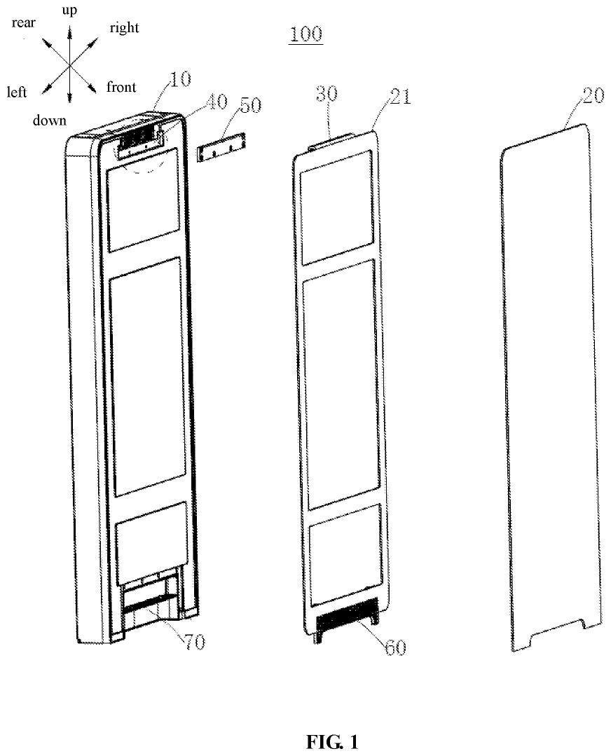

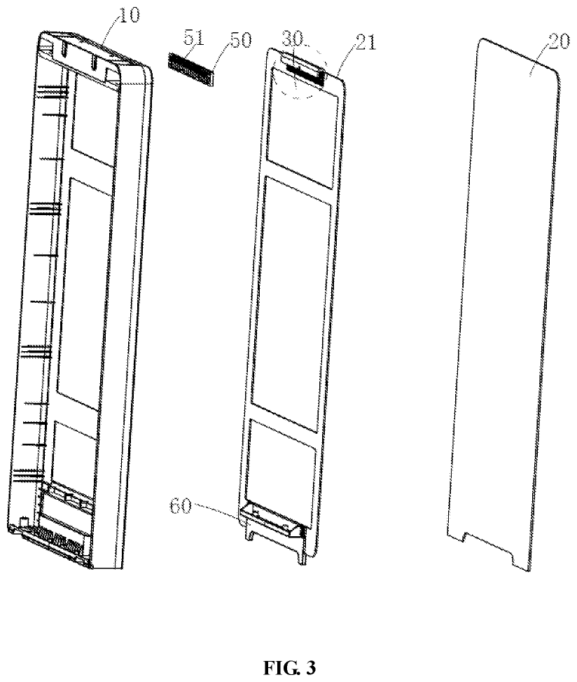

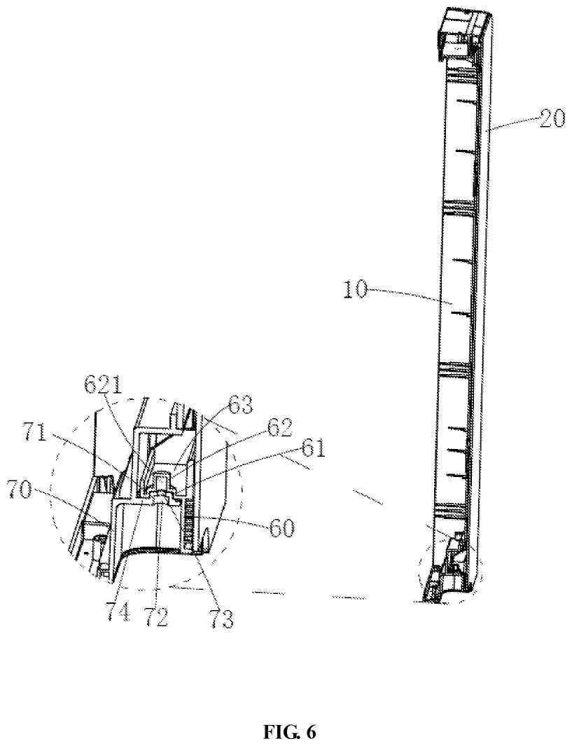

As shown in FIG. 1 through FIG. 6, a refrigerator door 100 with a replaceable door panel comprises: a foam door body 10, and a front panel 20 detachably connected to the foam door body 10, wherein a hook 30 is disposed on a rear side of the front panel 20, a hook groove 40 is disposed on a front side of the foam door body 10, a stopper 50 is disposed in the hook groove 40, the hook 30 is caught in the hook groove 40, and the stopper 50 elastically pushes and resists against the hook 30 in a front-rear direction.

In the present embodiment, the stopper 50 elastically pushes and resists against the hook 30 rearwardly in a direction perpendicular to the front panel 20, the hook 30 moves towards a rear groove wall 41 of the hook groove 40 and brings the front panel 20 towards the foam door body 10 so that the front panel 20 is attached to a front side of the foam door body 10, thereby preventing a gap from appearing between the front panel 20 and the foam door body 10 and refraining from affecting the beautiful appearance of the refrigerator door 100 with the replaceable door panel.

The “front-rear direction” mentioned above refers to a direction perpendicular to the front panel 20, and the rear groove wall 41 of the hook groove 40 is opposite to the rear side of the front panel 20.

It needs to be appreciated that when the stopper 50 pushes and resists against the hook 30, the stopper 30 only needs to provide the hook 30 with a component force in a direction perpendicular to the front panel 20 so that a displacement of the front panel 20 in the front-rear direction is limited.

As shown in FIG. 1 through FIG. 4, a frame 21 is disposed between the front panel 21 and the foam door body 10, the frame 21 is attached and secured to the rear side of the front panel 20, wherein the hook 30 is formed at an upper end of the frame 21 and protrudes towards the foam door body 10. However, the hook is not limited to this. In other embodiments of the present invention, the hook may be also formed on the rear side of the front panel and protrudes towards the foam door body.

Preferably, a front handle 60 is disposed at a lower end of the frame 21, wherein the lower end of the frame 21 is opposite to the upper end. The hook 30, the front handle 60 and the frame 21 are formed integrally. The hook 30, the front handle 60 and the frame 21 are mutually integrated into a one-piece structure and fixed to the rear side of the front panel 20 so that the assembling and detachment between the front panel 20 and the foam door body 10 is made simpler and more convenient.

In addition, the mutual integration of the hook 30, the front handle 60 and the frame 21 increases a contact area of the frame 21 and the rear side of the front panel 20 and enables better attachment of the frame 21 to the rear side of the front panel 20 made of a glass material.

As shown in FIG. 1 through FIG. 6, corresponding to the front handle 60, a rear handle 70 is disposed in an interior of the foam door body 10, and the rear handle 70 is disposed in a receiving groove at the lower end of the foam door body 10. After the front panel 20 is assembled with the foam door body 10 through the frame 21, a snap-fitting groove 61 on the front handle 60 and a boss 71 of the rear handle 70 snap-fit each other. The boss 71 comprises a cavity 72, and a top end of the boss 71 is provided with a through hole 73; a cap body 62 is disposed on a side of the snap-fitting groove 61 away from the boss 71, and the cap body 62 has a cavity 621; the through hole 73 communicates the cavity 72 with the cavity 621. A bolt passes through the cavity 72 and the through hole 73 in turn and enter the cavity 621, locking the boss 71 and the cap body 62 to each other, so that the front handle 60 and the rear handle 70 are locked in an up-down direction. The “up-down” direction is parallel to a height direction of the refrigerator door 100 with the replaceable door panel. The snap-fitting groove 61 snap-fits with the boss 71 to limit a displacement of the front handle 60 and the rear handle 70 in a horizontal direction, and the bolt passes through the cavity 72 and the through hole 73 of the boss 71 to lock with the cap body 62 of the snap-fitting groove 61 to limit the displacement of the front handle 60 and the rear handle 70 in the up-down direction.

Since the front handle 60 and the frame 21 are an integrated structure, and the frame 21 is attached and fixed on the rear side of the front panel 20, the displacement of the front panel 20 in the horizontal direction and up-down direction is also limited after the front handle 60 and the rear handle 70 are fixed to each other.

In the present embodiment, the front handle 60 and the rear handle 70 are respectively hidden between the foam door body 10 and the front panel 20, and belong to hidden handles.

In addition, the boss 71 is formed on a first plate 74 of the rear handle 70, and the snap-fitting groove 61 is formed on a second plate 63 of the front handle 60, wherein the first plate 74 and the second plate 63 extend opposed to each other, and the first plate 74 is superimposed below the second plate 63 after the front handle 60 and the rear handle 70 are assembled.

Further referring to FIG. 1 through FIG. 6, the hook 30 comprises a connecting portion 31 and a bent portion 32. Opposite ends of the connecting portion 31 are respectively connected to the frame 21 and the bent portion 32. The bent portion 32 comprises a resisting surface 321, which is parallel and opposite to the rear side of the front panel 21, wherein the stopper 50 elastically pushes and resists against the resisting surface 321 of the hook 30.

In the present embodiment, the hook 30 and the frame 21, for example, are an integrally-formed sheet metal member, and an upper end of the sheet metal member is bent to form a hook structure. A plurality of reinforcing ribs 33 are protrudingly provided on a lower surface of the hook 30, and the reinforcing ribs 33 are bent and extend from the upper end of the frame 21 to the resisting surface 321. The reinforcing ribs 33 is used to reinforce the strength of the hook 30 in the sheet metal member, improve a force-bearing capacity of the hook 30, and enhance the stability of the refrigerator door 100 with the replaceable door panel.

The stopper 50 is disposed in the hook groove 40 on the front side of the foam door body 10, an opening is formed on a side of the hook groove 40 facing towards the front panel 40, and the stopper 50 is assembled to the hook groove 40 through the opening. The hook groove 40 further comprises a step 43, and the stopper 50 is mounted on the step 43. Furthermore, a gap 401 is disposed between a top end of the stopper 50 and a top groove wall of the hook groove 40, and the hook 30 is mounted to an interior of the hook groove 40 through the gap 401.

The stopper 50 comprises a body portion 52 and an elastic portion 51, wherein the elastic portion 51 is located behind the body portion 52 and protrudes towards the side of the rear groove wall 41 of the hook groove 40. When the hook 30 is added to the hook groove 40, the elastic portion 51 elastically pushes and resists against the resisting surface 321 of the bent portion 32 of the hook 30.

In the present embodiment, an upper end of the elastic portion 51 is connected to a top end of the body portion 52, and a lower end of the elastic portion 51 is suspended at a rear side of the body portion 52 and forms a gap 53 with the body portion 52. When the elastic portion 51 elastically interacts with the bent portion 32 of the hook 30, the gap 53 may provide a deformation space for the elastic portion 51.

For example, when the refrigerator door 100 with the replaceable door panel is impacted by an external force, the elastic portion 51 is deformed to overcome the impact of the external force on the door body, thereby achieving the buffering and shock-absorbing effect without affecting the elastic portion 51 in elastically pushing and resisting against the hook 30; alternatively, when the front panel 20 is detached from the foam door body 10, the hook 30 squeezes the elastic portion 51. After the elastic portion 51 is deformed, it makes partial space so that the hook 30 can be more easily disengaged from the hook groove 40, thereby making the detachment of the front panel 20 easier.

In addition, the elastic portion 51 is an inclined structure. Specifically, the upper end of the elastic portion 51 extends obliquely downward along a top of the body portion 52 toward the bottom end of the body portion 52, so that the elastic portion 51 has an obliquely downward slope. The slope may guide the hook 30 to be assembled and detached, which makes the mounting and detachment of the front panel 20 more smooth.

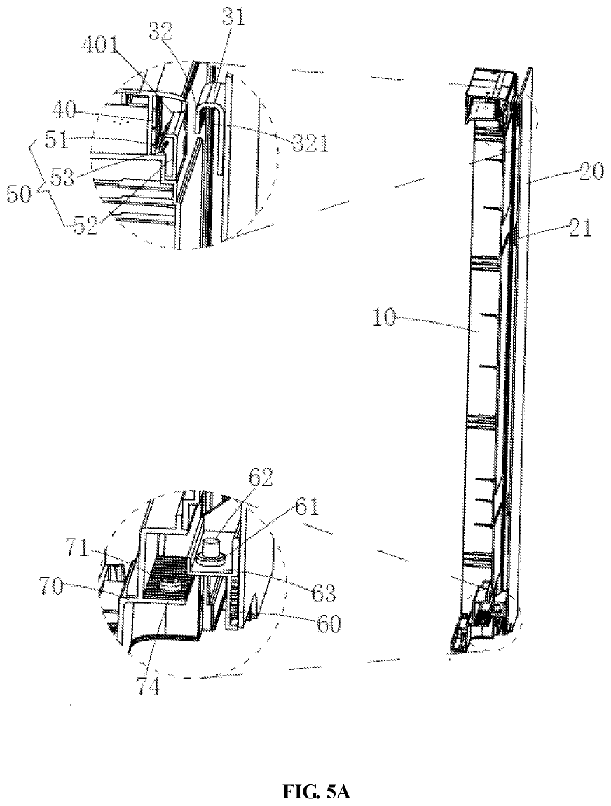

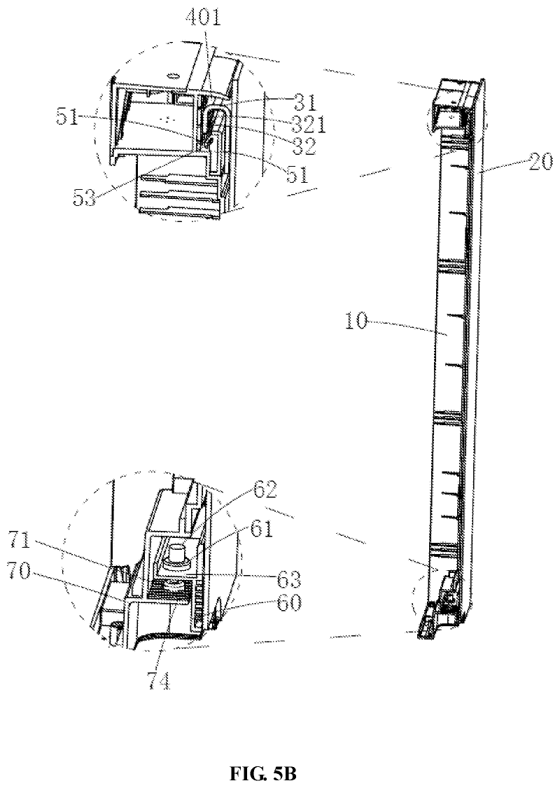

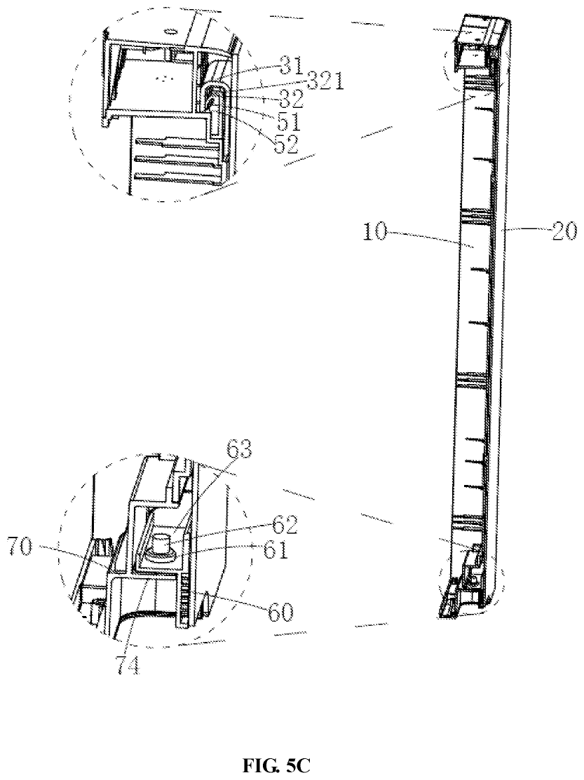

As shown in FIG. 5A through FIG. 5C, the assembling process of front panel 20 and foam door body 10 is roughly as follows:

First, the hook 30 on the frame 21 at the rear side of the front panel 20 is inserted into the hook groove 40 through the gap 401; then, the front panel 20 is pushed to come close to the foam door body 10, whereupon the bent portion 32 of the hook 30 moves towards the rear groove wall 41 of the hook groove 40; then, the bent portion 32 moves along the rear groove wall 41 towards the bottom groove wall of the hook groove 40. The resisting surface 321 of the bent portion 32 is pushed back elastically by the elastic portion 51 of the stopper 50 in the direction perpendicular to the front panel 20, the hook 30 is snap-fitted in the hook groove 40, and the front panel 20 is closely attached to the front side of the foam door body 10.

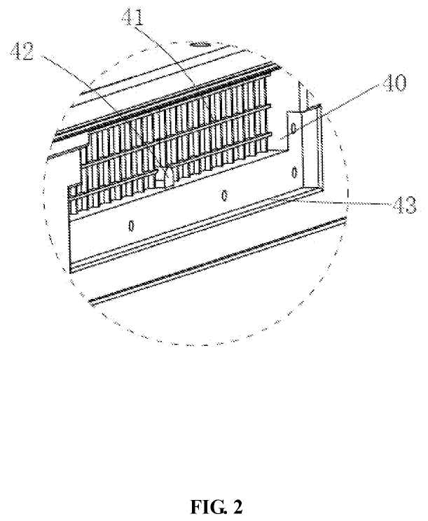

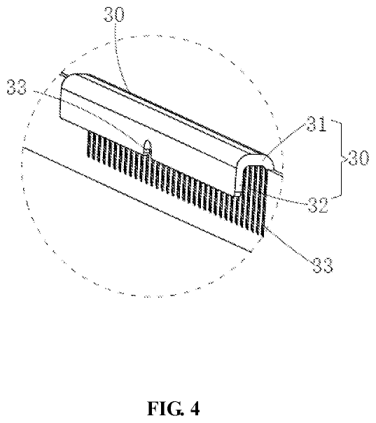

As shown in FIG. 2 and FIG. 4, the bent portion 32 is provided with a positioning notch 33, and a positioning block 42 is disposed on the rear groove wall 41 of the hook groove 40. When the front panel 20 is assembled on the front side of the foam door body 10, the positioning notch 33 on the bent portion 32 and the positioning block 42 on the rear groove wall 41 of the hook groove 40 engage each other to limit the displacement of the hook 30 in the hook groove 40 in a left-right direction, wherein the left-right direction is consistent with a width direction of the refrigerator door 100 with the replaceable door panel.

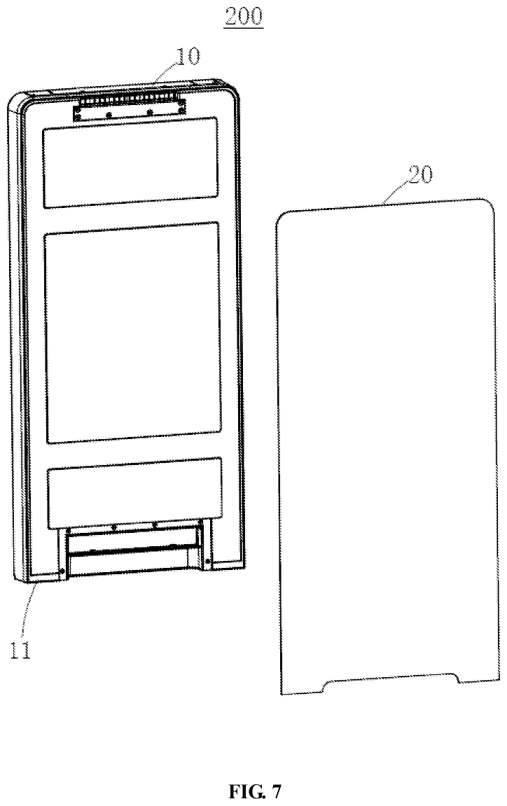

As shown in FIG. 7, a refrigerator door 200 in another embodiment of the present invention differs from the refrigerator door 100 with the replaceable door panel in that the refrigerator door 200 further comprises an adhesive layer which is disposed on a front side of the frame 11 of the foam door body 10. After the front panel 20 is assembled with the foam door body 10, the adhesive layer may be used to fix the front panel 20 to the frame 11 of the foam door body 10.

The adhesive layer is, for example, a double-sided adhesive layer or a hot melt adhesive layer.

In addition, in other embodiments of the invention, the frame and hook structure at the rear side of the front panel may be removed, and the adhesive layer may be directly formed at a rim of the foam door body. At this time, after being assembled to each other, the front handle and the rear handle are mounted together in the receiving groove at the lower end of the foam door body. At this time, it is only necessary to directly stick and fix the front panel to the front side of the foam door body through the adhesive layer.

It should be noted that in the solution of undetachable fixation and connection (fixation by applying an adhesive) of the front panel to the front side of the foam door body as compared with the solution of the detachable fixation and connection of the front panel to the front side of the foam door body, the foam door body itself is produced with the same set of molds, thereby facilitating the reduction of the production cost.

To conclude, the present invention provides a refrigerator door with a replaceable door panel, wherein the hook on the rear side of the front panel is detachably connected with the hook groove on the front side of the foam door body, the stopper in the hook groove elastically pushes and resists against the hook in the front-rear direction so that the front panel is attached to the front side of the foam door body, whereby the replacement of the front panel of the refrigerator door with the replaceable door panel is more convenient, and the appearance of the refrigerator door with the replaceable door panel is more beautiful.

It should be understood that although the description is described according to the embodiments, not every embodiment only comprises one independent technical solution, that such a description manner is only for the sake of clarity, that those skilled in the art should take the description as an integral part, and that the technical solutions in the embodiments may be suitably combined to form other embodiments understandable by those skilled in the art.

The detailed descriptions set forth above are merely specific illustrations of feasible embodiments of the present invention, and are not intended to limit the scope of protection of the present invention. All equivalent embodiments or modifications that do not depart from the art spirit of the present invention should fall within the scope of protection of the present invention.

What is claimed is:

1. A refrigerator door with a replaceable door panel, wherein the refrigerator door comprises:
a foam door body, and a front panel detachably connected to the foam door body;
wherein a hook is disposed on a rear side of the front panel, a hook groove is disposed on a front side of the foam door body, a stopper is disposed in the hook groove, the hook is caught in the hook groove, and the stopper elastically pushes and resists against the hook in a front-rear direction.

2. The refrigerator door with a replaceable door panel according to claim 1, wherein the stopper elastically pushes and resists against the hook rearwardly in a direction perpendicular to the front panel.

3. The refrigerator door with a replaceable door panel according to claim 1, wherein the refrigerator door further comprises a frame and a front handle, the frame is attached to a rear side of the front panel, the hook is disposed at an upper end of the frame, and the front handle is disposed at a lower end of the frame, where the hook, the front handle and the frame are formed integrally.

4. The refrigerator door with a replaceable door panel according to claim 3, wherein the refrigerator door further comprises a rear handle, the rear handle is disposed in a receiving groove of the foam door body, where after the front panel is assembled with the foam door body, a snap-fitting groove on the front handle and a boss on the rear handle snap-fit each other.

5. The refrigerator door with a replaceable door panel according to claim 4, wherein a top end of the boss is provided with a through hole, a cap body is disposed on a side of the snap-fitting groove away from the boss, and a cavity of the cap body and the through hole are communicated with each other, where a bolt passes through the through hole and the cavity of the cap body in turn and interlocks the front handle with the rear handle.

6. The refrigerator door with a replaceable door panel according to claim 3, wherein the hook comprises a bent portion and a connecting portion, both ends of the connecting portion are respectively connected to the bent portion and the frame, wherein the bent portion comprises a resisting surface which is parallel and opposite to a rear side of the front panel, and wherein the resisting surface elastically abuts against the stopper.

7. The refrigerator door with a replaceable door panel according to claim 6, wherein the stopper comprises a body portion and an elastic portion, the elastic portion is located behind the body portion and protrudes towards an interior of the hook groove, and the elastic portion elastically pushes and resists against the resisting surface.

8. The refrigerator door with a replaceable door panel according to claim 7, wherein an upper end of the elastic portion is connected to a top end of the body portion, and a lower end of the elastic portion is suspended at a rear side of the body portion and forms a gap with the body portion.

9. The refrigerator door with a replaceable door panel according to claim 7, wherein the elastic portion extends obliquely downward along a top end of the body portion toward a bottom end of the body portion.

10. The refrigerator door with a replaceable door panel according to claim 6, wherein a positioning block is disposed in the hook groove, a positioning notch is disposed on the bent portion, where when the front panel is assembled on the front side of the foam door body, the bent portion is inserted in the hook groove, and the positioning notch and the positioning block snap-fit each other.
